(19) United States
(12) Patent Application Publication
(10) Pub. No.: US 2016/0125452 A1
(43) Pub. Date: May 5, 2016

(54) Measuring Offsite Advertising Effectiveness

(71) Applicant: Facebook, Inc., Menlo Park, CA (US)

(72) Inventors: Patrick James Kemp, Menlo Park, CA (US); Frederick Ross Leach, San Francisco, CA (US)

(21) Appl. No.: 14/527,151

(22) Filed: Oct. 29, 2014

(51) Int. Cl. G06Q 30/02

(52) U.S. Cl. CPC G06Q 30/0245; G06Q 30/0267

(57) ABSTRACT

A polling system polls users of mobile devices to measure the impact of advertisements provided by another system on user attitudes and provides a common comparison metric to advertisements being measured by the polling system. The polling system maintains user demographics information of users of the polling system and stores a device identifier for users logged in to the polling system or a related service. When a mobile device accesses an advertisement at a third party advertising provider, the polling system receives an advertisement identifier for the advertising impression and a device identifier for the device providing the impression. The polling system matches received device identifiers with device identifiers for logged-in users to identify when a user of the polling system receives advertisements by third party systems. The polling system provides advertisements to the users, polls the users relating to the advertiser, and calculates a lift metric measuring advertising effectiveness.

### BACKGROUND

This invention relates generally to measuring advertising effectiveness, and in particular to measuring user responses to polling data based on advertising exposure.

Determining the effectiveness of an advertisement is difficult for advertisers. Even when a user does not immediately perform any action with respect to an advertisement, for example by following the advertisement to the advertiser's website, the impression of the advertisement on the viewer may still affect a user's perception of the advertiser and advertised product. One method of determining a user's attitude towards an advertisement includes polling users to determine whether user poll responses improve when an advertisement is shown to a user. However, to determine the advertisement's effectiveness, a polling system must identify a group of users that have seen the advertisement (a test group) and a group of users that have not seen the advertisement (a holdout group). Identifying which users have seen and have not seen the advertisement can be particularly difficult when the user views the advertisement via a third party application that does not report advertisement impressions to the polling system.

### SUMMARY

An online polling system computes a lift metric that measures lift caused by ads provided to mobile device users on a third party application. The lift metric may measure the lift of the advertisement provided by the third party application, and may also measure lift caused by ads provided by the online polling system for a group of users who have seen the ad outside of the mobile application and for a group of users who have not.

A mobile device presents advertisements to a user in a third party application that does not send advertising impressions to the polling system. The third party application communicates with an advertising provider to obtain advertisements and presents the advertisements to a user of the mobile device. When the advertisement is presented, the third party application reports the advertising impression to an advertising impression manager and includes a device identifier of the mobile device. The mobile device also includes a polling application in communication with the online polling system. The polling application presents polls to the user of the mobile device, permits users to login to the polling system via the polling application, and sends the device identifier to the polling system.

The online polling system receives advertising impressions from an advertising impression manager. The advertising impressions indicate advertisements presented to a user at a mobile device, and includes an advertisement identifier and a mobile device identifier. The polling system associates users of the polling system with advertising impressions provided by the advertising impression manager by matching the device identifier provided by the advertising impression manager with a device identifier of a user logged in to the polling system via the polling application. The polling system may also provide its own advertisements to the mobile device for display on the polling application.

The polling system measures the effectiveness of an advertisement, including advertisements provided by the third party application, by providing polls to users of mobile devices. The polling system identifies a test and a holdout group for the polling. The holdout group is not associated with viewing the advertisement being tested, and the test group is associated with an advertising impression for the advertisement. In one example, the holdout group includes users that did not view the third party advertisement, and the test group includes users that did view the third party advertisement. The polling system provides polls to the holdout and test groups of users, and computes a lift metric describing the comparative poll results of the test group relative to the holdout group. In another example, the test group includes users that were provided an advertisement via the polling application, and the holdout group includes users that were not provided an advertisement via the polling application. In this example, the holdout group may also be identified to restrict a set of users from receiving advertisements from the polling system. By receiving device identifiers from the advertising impression system and matching the device identifiers to users of the polling system, the polling system can effectively identify and measure responses of groups of users that have had different advertising exposure.

### BRIEF DESCRIPTION OF THE DRAWINGS

FIG. 1 is a high level block diagram of a system environment for a polling system.

FIG. 2 is an example block diagram of an architecture of a polling system.

FIG. 3 shows a polling data table indicating advertisement impressions and poll results according to one embodiment.

FIG. 4 shows the selection of test and holdout groups for the calculation of a lift metric according to one embodiment.

FIG. 5 shows a sample poll results summary that summarizes poll results and lift metrics for the subject advertisement.

FIG. 6 shows a method of generating a lift metric according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

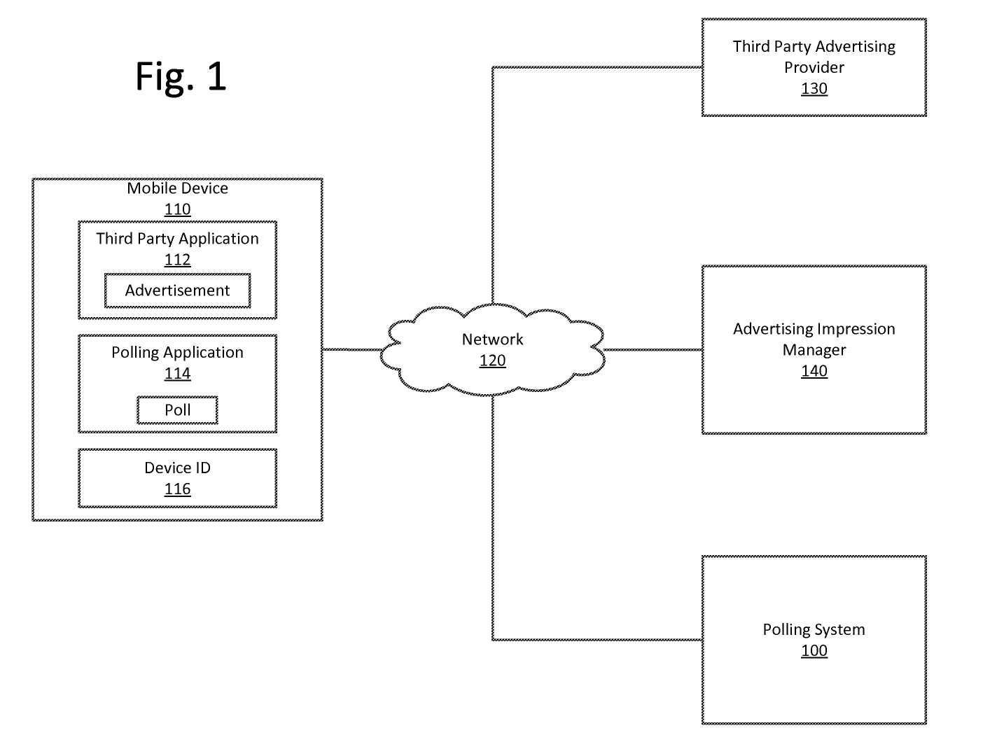

FIG. 1 is a high level block diagram of a system environment for a polling system 100. The system environment shown by FIG. 1 comprises one or more mobile devices 110, a network 120, one or more third party advertising providers 130, and an advertising impression manager 140. In alternative configurations, different and/or additional components may be included in the system environment. The embodiments described herein can be adapted to various online systems that measure advertising effectiveness, and may be included in various systems, such as a social networking system.

A third party advertising provider 130 provides advertisements to the mobile device 110 for presentation to the user of the mobile device. The third party advertising provider 130 may be an advertising bidding platform, such as an advertising exchange or other system that consolidates available advertising exposures and matches available advertising slots (e.g., locations at which an advertisement could be provided) with advertisers. Advertisers provide advertisements for presentation to users via a third party advertising provider 130.

Advertising impression manager 140 consolidates advertising impression information from many mobile devices, and may consolidate advertising impression information from many third party advertising providers 130. The advertising impression manager 140 provides data analytics and other services to advertisers. The advertising impression manager 140 may also maintain demographics and other data about users. An application developer that uses advertisements from third party advertising provider 130 may be instructed to report advertising impressions to the advertising impression manager, for example by using a software development kit (SDK) provided by the advertising impression manager 140 and incorporating elements of the SDK into applications that provide ads to users on a mobile device.

The advertising impression manager 140 receives advertising impressions from applications on various mobile devices 110. The advertising impressions include an identifier of the advertisement presented to the user, along with a device identifier of the mobile device that displayed the advertisement. The advertising impression is stored by the advertising impression manager 140 to track impressions of the advertisement, and the advertisement impression is sent by the advertising impression manager 140 to the polling system 100. The advertising impression manager 140 may also send the demographics and other data about users to the polling system 100.

The polling system 100 provides analysis for the advertising impressions provided by advertising impression manager 140. The polling system 100 provides polls to mobile devices 110 and receives poll results. The polling system 100 may be a stand-alone system or may be incorporated into a larger system, such as on a social networking system. The polling system 100 may also provide advertisements of its own to the mobile device 110. Advertisements provided by the polling system or by a system on which the polling system operates (e.g., a social networking system) and displayed on polling application 114 are termed onsite advertisements (i.e., “onsite” with respect to the polling system) and advertisements provided to a user in third party application 112 are termed offsite advertisements. A given advertiser may advertise to a user via both onsite and offsite advertisements. As more fully described below, the polling system 100 identifies users that were provided the offsite ads, and performs analysis for an advertiser for the users targeted by these offsite ads. In one type of analysis, the polling system 100 provides polls to users of the polling system and measures the lift of the offsite ads on poll responses.

The mobile devices 110 are one or more computing devices capable of receiving user input as well as transmitting and/or receiving data via the network 120. A client device 110 may be a device having computer functionality, such as a personal digital assistant (PDA), a mobile telephone, a smartphone or another suitable device. A mobile device 110 is configured to communicate via the network 120. In one embodiment, a mobile device 110 executes an application allowing a user of the mobile device 110 to interact with various systems in the environment of FIG. 1. For example, a mobile device 110 executes a browser application to enable interaction between the mobile device 110 and the polling system 140 via the network 120. In another embodiment, a mobile device 110 interacts with the polling system 140 through an application programming interface (API) running on a native operating system of the client device 110, such as IOS® or ANDROID™.

The mobile device 110 provides advertisements and polls to users of the mobile device. The mobile device 110 executes applications and other processes for the user of the mobile device 110. Many applications offered by the mobile device 110 also provide advertisements to the user of the mobile device 110, such as third party application 112. To provide advertisements to the user, the third party application 112 communicates with a third party advertising provider 130, which provides an advertisement for presentation to the user of the mobile device 110. The third party application 112 may also implement an SDK or other toolkit provided by an advertising impression manager 140. The SDK provides a convenient programming interface for a programmer of the third party application 112 to log and track advertising impressions presented on the third party application 112. When an advertisement is presented on the third party application 112, the third party application sends an indication of the advertising impression to the advertising impression manager 140. This indication may be sent via the SDK of the advertising impression manager 140.

In addition to the advertisement impression, the third party application 112 also obtains a device identifier 116 of the mobile device. The device identifier uniquely or near-uniquely identifies a mobile device, and may be a static value maintained by hardware or an operating system of the mobile device. The mobile device identifier may also describe an operating environment or other unique characteristic of the mobile device. The operating environment may include particular applications installed on the mobile device, an operating system, location or networking information of the device, and other information about the mobile device that may uniquely identify the mobile device. The third party application 112 reports the advertising impression along with the device identification to the advertising impression manager 140.

The mobile device 110 includes a polling application 114. The polling application 114 receives polls from the polling system 100 and provides the polls to the user of the mobile device 110. The polling application 114 may also provide a login interface for the user of the mobile device to login to the polling system 100. When a user logs in to the polling application 114, the polling application retrieves the device identifier and provides the device identifier to the polling system 100. The polling application 114 may be an application dedicated to polling, or may be incorporated into another application at the mobile device 110. For example, the polling application may provide polls to users operating other applications on the mobile device 110. The polling application 114 may incorporate additional functionality, for example permitting users to message other users, interact with content items stored at polling system 100, and incorporate other features of interest to users. In one embodiment, the polling application 114 incorporates social networking features and communicates with a social networking system to provide social networking content and interactions to the user of the device.

The polls provided by polling application 114 may request the user to fill out a survey or answer questions relating to a particular product, advertisement, or other inquiry. In one example poll, a user is asked questions relating to gifting and flowers. In this example, a user may be asked how likely the user is to give flowers as a gift, the user's general attitude towards flowers, and what company the user would purchase flowers from. These polls enable measurement by the polling system 100 of the attitudes held by a user, and in this example may be used to track attitudes towards a flower company that has advertised via third party advertising provider 130 and/or polling system 100.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

As an alternative, one configuration of the polling system 100 receives the device identification from the mobile device 110 responsive to a redirect when the mobile device 110 accesses third party advertising provider 130. In this alternative, the third party advertising provider provides an advertisement to the third party application 112 and redirects the third party application to access the polling system 100 with a device identifier and an advertisement identifier. This redirect may be performed via a link or other reference provided by the third party advertising provider 130. In this configuration, the polling system 100 may perform the various functions of advertising impression manager 140.

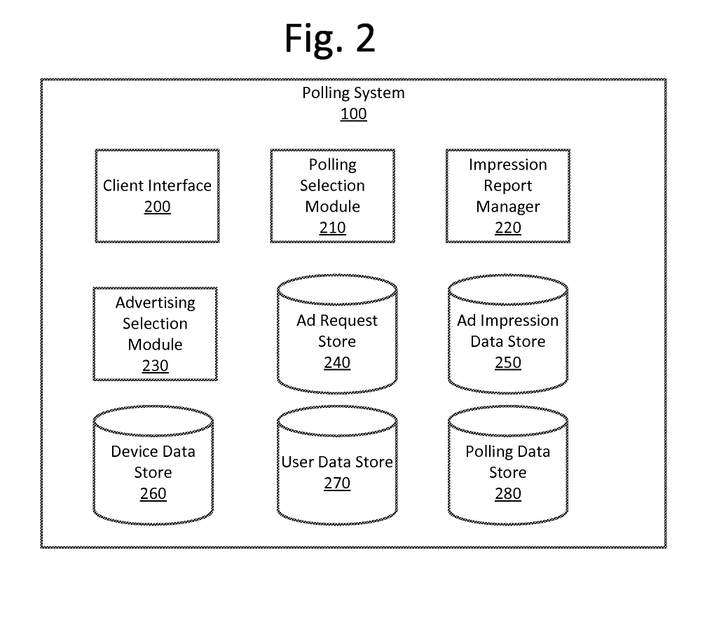

FIG. 2 is an example block diagram of an architecture of a polling system 100. The polling system shown in FIG. 2 includes a client interface 200, polling selection module 210, impression report manager 220, and advertising selection module 230. The polling system 100 also includes an ad request store 240, ad impression data store 250, a device data store 260, a user data store 270, and a polling data store 280. Conventional components such as network interfaces, security functions, load balancers, failover servers, management and network operations consoles, and the like are not shown so as to not obscure the details of the system architecture.

Each user of the polling system 100 is associated with a user profile, which is stored in the user data store 270. A user profile includes declarative information about the user that was explicitly shared by the user and may also include profile information inferred by the polling system 100. In one embodiment, a user profile includes multiple data fields, each describing one or more attributes of the corresponding user of the polling system 100. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the polling system 100 displayed in an image. A user profile in the user data store 270 may also maintain references to actions by the corresponding user performed on content items stored at the polling system 100.

One or more advertisement requests (“ad requests”) are included in the ad request store 240. An advertisement request includes advertisement content and a bid amount. The advertisement content is text, image, audio, video, or any other suitable data presented to a user. The bid amount is associated with an advertisement by an advertiser and is used to determine an expected value, such as monetary compensation, provided by an advertiser to the polling system 100 if the advertisement is presented to a user, if the advertisement receives a user interaction, or based on any other suitable condition. For example, the bid amount specifies a monetary amount that the polling system 100 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with content in the advertisement request. For example, targeting criteria are a filter to apply to fields of a user profile, edges, and/or actions associated with a user to identify users having user profile information, edges or actions satisfying at least one of the targeting criteria. Hence, the targeting criteria allow an advertiser to identify groups of users matching specific targeting criteria, simplifying subsequent distribution of content to groups of users.

The ad impression data store 250 stores advertising impressions provided to users of the polling system 100. The advertising impressions include onsite advertisements, provided by the polling system 100, and offsite advertisements, provided by a third party advertising provider 130. The ad impression data store includes an advertising identifier that identifies the particular advertisement provided to a user, and a user identifier, identifying the user in the user data store 270 that was provided the advertisement. The ad impression data store 250 may also receive advertising impressions from the offsite advertisements which are not identified with a particular user of the polling system 100.

The polling data store 280 maintains poll result data for polls completed by users. The poll result data includes a user identifier of the user that completed the poll, in addition to the user's corresponding answers to the poll questions. In one alternative, rather than storing a user identifier, the poll result data is associated with demographic and other profile data relating to the matching user, anonymizing the poll result from a specific user identity. The polling data store may also include poll questions for a poll, indicating specific questions to be answered in the poll and specific answers that may be provided by users in response to the poll question. For example, certain questions may be answered in various ways, such as a boolean yes/no, a selection among several options, and a numerical rating. The poll may also be associated with desired answers by the advertiser, for example preferring “yes” to “no,” a specific option selection, and so forth.

A device data store 260 maintains information associating logged-in users with particular mobile devices 110. Particularly, a user may be logged-in to the polling system 100, and the device identifier provided by the polling application 114 during the login process is stored with the device data store 260. Rather than a log-in to the polling system 100, the user may be associated with a login to another service on which the polling system 100 operates, such as a social networking system. When a user logs out of the polling system 100, the user may be disassociated with the device identifier at the device data store 260, or a logged-in status may be changed to reflect that the user is not currently logged in to that device. In addition, in one configuration, the user may be logged into multiple devices simultaneously. The device data store 260 may also clear the login status for a device that has not interacted with the polling system 100 within a threshold amount of time such as a week or a month.

The client interface 200 provides an interface to the mobile device 110 to the polling system 100. The client interface 200 provides a login interface for the user of the mobile device 110 to log in to the polling system 100. When a client logs in to the polling system 100, the client interface 200 receives a device identifier from the mobile device 110 and associates the device identifier with the logged-in user at the device data store 260. The client interface 200 also receives polls from the polling selection module 210 and provides polls to the polling application 114. The client interface 200 may also select various content stored at the polling system 100, for example in a newsfeed or other data feed for the user. The polls send to the polling application 114 may be integrated within the newsfeed for the user or with other content provided to the polling application 114. When users complete polls at the mobile device 110, the poll results are received by the client interface 200 and stored at polling data store 280.

The polling selection module 210 identifies users to receive a poll from the polling system 100. The polling selection module 210 accesses polls stored in the polling data store 280 and identifies a holdout and test group for the poll. The poll may identify targeting criteria for users to be targeted with the poll, such as users within particular demographics profile or users with particular interests in the user data store 270. The poll indicates one or more lift metrics desired by the advertiser as a result of the poll. For example, to determine the effectiveness of an offsite advertisement, or to determine the effectiveness of an offsite advertisement in conjunction with an onsite advertisement. The holdout group identified by the polling selection module 210 includes users of the polling system 100 that have not received the subject advertisement. The test group identifies users that have (or will) receive the subject advertisement. For example, to determine effectiveness of the offsite advertisement relative to users that have not seen the offsite advertisement, the holdout group includes users of the user data store 270 that are not associated with impressions of the offsite advertisement in the ad impression data store 250, while the test group includes users that are associated with impressions of the offsite advertisement.

To measure test and holdout groups for onsite ad impressions, the polling selection module 210 provides an identification of the test and holdout groups to the advertising selection module 230 to permit providing the subject ad to the test group and avoid providing the subject ad to the holdout group. The polling selection module 210 may provide specific users to the advertising selection module 230 to identify the holdout groups for the advertising selection module 230, or the polling selection module 210 may indicate that a particular advertisement is subject to a poll, and the advertising selection module 230 automatically withholds that advertisement to certain users that meet the targeting criteria in order to generate the holdout group.

The advertising selection module 230 selects and provides advertisements to the mobile device 110 from the polling system 100. The advertisements are selected from the ad request store 240 based on a match between targeting criteria of the advertisements and information known about a user in the user data store 270. The advertising selection module 230 may also perform bidding and other ad selection techniques to select from among advertisements competing to be shown at the mobile device 110. When an advertisement is selected and provided to the mobile device 110 for display, the advertising selection module 230 stores an identification of the advertisement impression at the ad impression data store 250 along with a user identifier of the user receiving the advertisement. The advertising selection module 230 also receives an identification of a holdout and target group for an advertisement from the polling selection module 210. When a user is selected as a member of the holdout group, the advertising selection module 210 excludes the subject advertisement from being provided to that user.

The impression report manager 220 receives advertising impressions from the advertising selection module 230 and the advertising impression manager 140 to track advertising impressions. The impression report manager 220 receives the advertising impression from the advertising impression manager 140, which includes an advertisement identifier and a device identifier for the device on which the advertisement was provided. The impression report manager 220 queries device data store 260 to determine whether any users are logged in and associated with the device identifier of the advertisement impression. When a logged in user has a device identifier at device data store 260 matching the device identifier of the advertisement, the advertisement is associated with the user and stored at ad impression data store 250. In addition to storing these offsite advertisements at the ad impression data store 250, the impression report manager may also store impressions of onsite ads (i.e., the ads provided by polling system 100) at the ad impression data store 250.

The impression report manager 220 also generates reports associated with the advertising impressions at ad impression data store 250. For example, the impression report manager may analyze the polling results and generate lift metrics for the poll. The lift metrics indicate, for example, the improved poll responses for users that were provided an advertisement relative to users that were not provided an ad. The lift metrics may be performed, for example, based on the test and holdout groups of users and indicate the response rates of the test group relative to the holdout group. The lift metrics measure the poll responses with respect to the desired poll responses by the advertiser. For example, the advertiser may select “yes” as the preferred response to one question, and “10” as the preferred response to another.

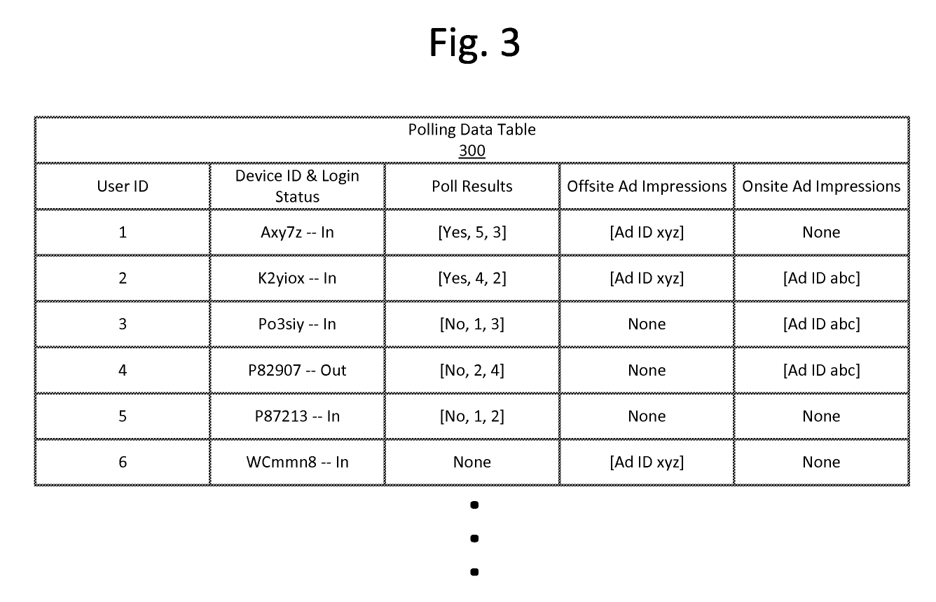

FIG. 3 shows a polling data table 300 indicating advertisement impressions and poll results according to one embodiment. In one embodiment, the impression report manager generates polling data table 300 or accesses similar data to the polling data table 300 to generate lift metrics for an advertisement. Thus, while the polling data table 300 is shown here for convenience, the various data shown as a part of the polling data table 300 may be separately stored at the various data stores of the polling system 100. The polling data table 300 stores user identifiers and related information for the user identifiers. As noted above, rather than identifiers of individual users, the users may be identified by demographics information or by information that is not personally identifiable. In this example, the polling data table 300 also identifies whether a user is associated with a particular device identifier and whether the user is logged in to that device identifier. When polled, the user identifier is associated with poll results, and when presented advertisements, the offsite and onsite ad impressions provided to the user are also stored for the user. As shown by the polling data table 300, various users may be associated with offsite and onsite ad impressions. For user identifier 4, the user is indicated as not logged in to the polling system by the login status. As such, if an offsite ad impression is received designating that device identifier (“P82907”), that advertisement is not associated with user identifier 4, since the user is not logged in to the polling system 100.

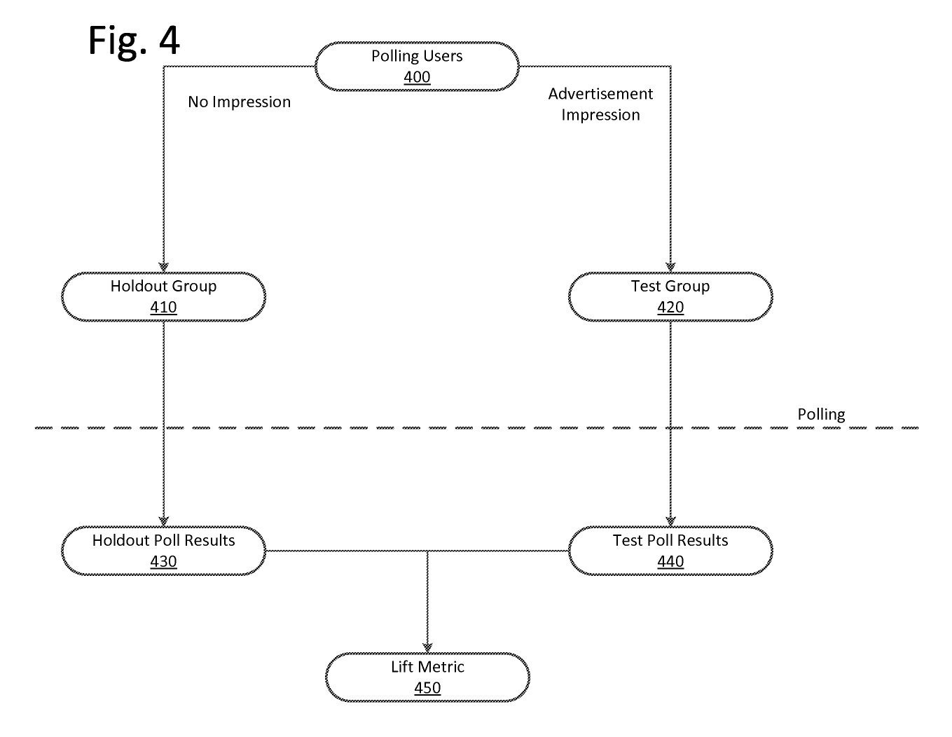

FIG. 4 shows the selection of test and holdout groups for the calculation of a lift metric. As shown in FIG. 4, a set of polling users 400 is selected for a poll. The polling users 400 may be selected from the general population of users of the polling system 100 using targeting criteria of the poll. Next, a holdout group 410 and a test group 420 are identified from the set of polling users 400 for a subject advertisement. The holdout group includes users that have not viewed the advertisement, and the test group includes users that have or will view the advertisement. The designation of holdout and test groups may be sent to the advertising selection module to control distribution of the subject advertisement. Next, if the test group has not viewed the advertisement, the test group views the advertisement, for example by being served ads from ad selection module 230. After the test group has received the advertisements, the test and holdout groups are provided a poll and the polling system receives holdout poll results 430 for the holdout group 410 and test poll results 440 for the test group 420. Using the poll results, various lift metrics 450 can be calculated, such as the difference in lift for various responses of the poll based on exposure to the subject advertisement.

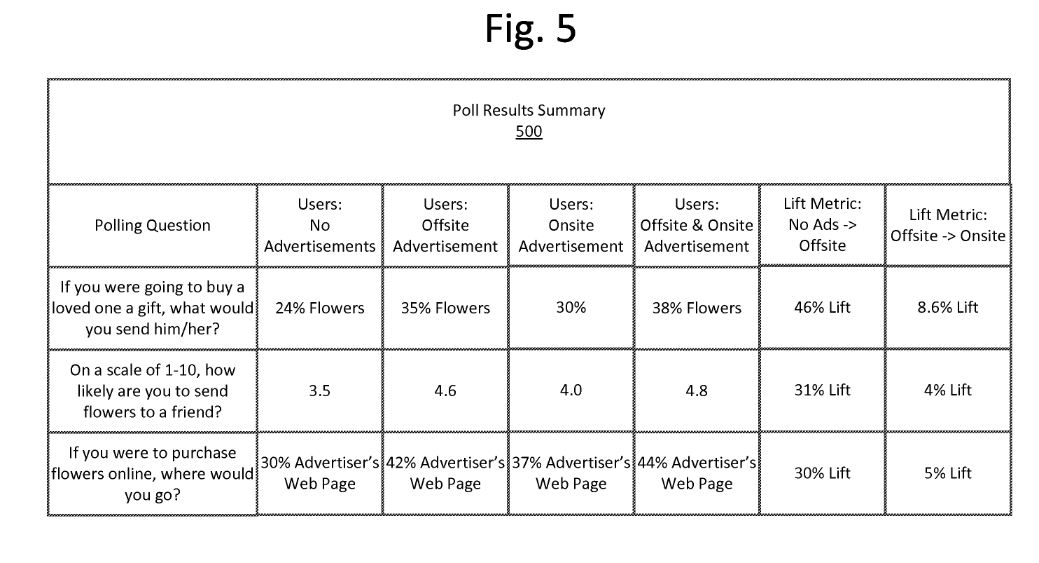

FIG. 5 shows a sample poll results summary 500 that summarizes poll results and lift metrics for the subject advertisement. In this example, the poll relates to gifting and flowers, and advertisements are presented to users that have viewed and have not viewed the advertisement onsite and offsite. Thus, in this example there are four sets of users who have viewed the following combinations of advertisements: no advertisements, only the offsite advertisement, only the onsite advertisement, and both the onsite and offsite advertisement. In this example, lift metrics are measured for each poll question, first to compare the no-advertisement group with the offsite advertisement group, and second to compare to the offsite advertisement group to the onsite advertisement group. By performing the polls and related analysis, advertisers are able to identify the value of the offsite advertisement and its effect on user attitudes. In addition, onsite advertising can also be evaluated for users that have and have not seen the offsite advertisement. This may permit, for example, an advertiser to more aggressively target onsite or offsite advertisements, or advertise more frequently via the advertising system that provides higher lift. Since the offsite advertisement impression can be tracked on the polling system via the device identifier, the polling system 100 can determine users that have viewed offsite advertisements and successfully measure a lift metric relating to the offsite advertisements using poll results.

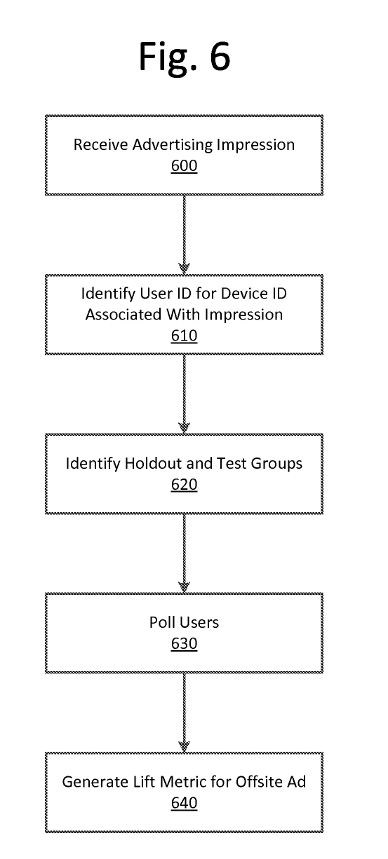

FIG. 6 shows a method of generating a lift metric according to one embodiment. This method is performed by the polling system 100 in one embodiment. The polling system receives an advertising impression 600 indicating an offsite advertisement and a device identifier that provided the advertisement to the user. Next, the polling system identifies 610 a user identifier that is associated with a device identifier matching the device identifier provided with the advertising impression. The advertising impression is associated with the identified user. To begin identifying lift metrics for the offsite advertisement, the system identifies 620 test and holdout groups of users. The test groups identify users that were not provided the subject advertisement, while the holdout users identify users that were provided the subject advertisement. In one embodiment, the holdout users are prevented from receiving the advertisements. Next, the test and holdout groups are polled 630 by the polling system. By comparing the poll results across different advertisement impression exposures, the system generates 640 a lift metric that indicates the effect of additional advertising on users, and in particular permits identification and measurement of users that have viewed an offsite ad.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, at a polling system and for an advertising impression at a mobile device of an advertisement provided by a third party system, an advertisement identifier, and a device identification of the mobile device;
identifying a target user associated with a stored device identification that matches the received device identification;
associating the target user with the advertisement identifier, the associating indicating that the target user has viewed the advertisement;
identifying a first set of users who are not associated with the advertisement identifier, the first set of users having not viewed the advertisement;
identifying a second set of users comprising users who are associated with the advertisement identifier, the second set of users having viewed the advertisement, wherein the second set of users includes the target user;
receiving poll results for a poll provided to the first set of users and the second set of users, the poll querying users about a subject matter of the advertisement; and
calculating a lift metric for the advertisement by comparing the poll results of the first set of users to the poll results of the second set of users.

2. The method of claim 1, wherein the advertisement identifier and device identification are received from the mobile device.

3. The method of claim 1, wherein the advertisement identifier and device identification are received by the polling system from an advertising impression manager that consolidates advertising impressions from a plurality of mobile devices.

4. The method of claim 1, wherein the matching device identification is selected from a plurality of device identifications each associated with a logged in user.

5. The method of claim 1, further comprising providing the poll to the first set of users and the second set of users, wherein providing the poll comprises inserting the poll into a newsfeed for each user.

6. The method of claim 1, wherein the device identification describes an operating environment of the mobile device.

7. The method of claim 1, further comprising:
providing an onsite advertisement to mobile devices of a portion of the first set of users, wherein the advertisement is provided prior to receiving the poll results; and
calculating a lift metric for the onsite advertisement by comparing the poll results of the portion of the first group of users to the poll results of the second set of users.

8. The method of claim 1, further comprising:
providing an onsite advertisement to mobile devices of a portion of the second group of users, wherein the advertisement is provided prior to receiving the poll results; and
calculating a lift metric for the onsite advertisement by comparing the poll results of the portion of the second group of users to the poll results of the remaining users in the second set of users who were not included in the portion of the second group of users.

9. A computer-readable medium comprising instructions, which when executed by a processor cause the processor to perform steps including:
receiving, at a polling system and for an advertising impression at a mobile device of an advertisement provided by a third party system, an advertisement identifier, and a device identification of the mobile device;
identifying a target user associated with a stored device identification that matches the received device identification;
associating the target user with the advertisement identifier, the associating indicating that the target user has viewed the advertisement;
identifying a first set of users who are not associated with the advertisement identifier, the first set of users having not viewed the advertisement;
identifying a second set of users comprising users who are associated with the advertisement identifier, the second set of users having viewed the advertisement, wherein the second set of users includes the target user;
receiving poll results for a poll provided to the first set of users and the second set of users, the poll querying users about a subject matter of the advertisement; and
calculating a lift metric for the advertisement by comparing the poll results of the first set of users to the poll results of the second set of users.

10. The computer-readable medium of claim 9, wherein the advertisement identifier and device identification are received from the mobile device.

11. The computer-readable medium of claim 9, wherein the advertisement identifier and device identification are received by the polling system from an advertising impression manager that consolidates advertising impressions from a plurality of mobile devices.

12. The computer-readable medium of claim 9, wherein the matching device identification is selected from a plurality of device identifications each associated with a logged in user.

13. The computer-readable medium of claim 9, wherein the instructions further causing the processor to perform the step of providing the poll to the first set of users and the second set of users, wherein providing the poll comprises inserting the poll into a newsfeed for each user.

14. The computer-readable medium of claim 9, wherein the device identification describes an operating environment of the mobile device.

15. The computer-readable medium of claim 9, wherein the instructions further causing the processor to perform steps including:
providing an onsite advertisement to mobile devices of a portion of the first set of users, wherein the advertisement is provided prior to receiving the poll results; and
calculating a lift metric for the onsite advertisement by comparing the poll results of the portion of the first group of users to the poll results of the second set of users.

16. The computer-readable medium of claim 9, wherein the instructions further causing the processor to perform steps including:
providing an onsite advertisement to mobile devices of a portion of the second group of users, wherein the advertisement is provided prior to receiving the poll results; and
calculating a lift metric for the onsite advertisement by comparing the poll results of the portion of the second group of users to the poll results of the remaining users in the second set of users who were not included in the portion of the second group of users.
